(19) United States
(12) Patent Application Publication
(10) Pub. No.: US 2026/0364502 A1
(43) Pub. Date: Nov. 19, 2026

(54) AIR FILTRATION SUBSTRATE AND MODIFICATION METHOD THEREOF

(71) Applicant: National Tsing Hua University, Hsinchu City (TW)

(72) Inventors: Jyh-Ming Wu, Hsinchu County (TW); Hsun-Yen Lin, Hsinchu City (TW); Sz Nian Lai, Hsinchu City (TW)

(73) Assignee: National Tsing Hua University, Hsinchu City (TW)

(21) Appl. No.: 19/267,647

(22) Filed: Jul. 14, 2025

(30) Foreign Application Priority Data
May 14, 2025 (TW) 114118038

(51) Int. Cl. B01D 46/00; B01D 39/16; C08J 7/12

(52) U.S. Cl. CPC B01D 46/0032; B01D 39/16; C08J 7/12; B01D 2239/0435; B01D 2239/0478; B01D 2239/10; C08J 2367/02

(57) ABSTRACT

An air filtration substrate and a modification method thereof are provided. The modification method of the air filtration substrate includes the following steps. The air filtration substrate is provided. A material of the air filtration substrate includes a first polymer or a second polymer. Thereafter, a surface of the air filtration substrate is modified with a modified solution, so that a hydroxyl group on the surface of the air filtration substrate is grafted and modified, thereby adjusting an electronegativity of the air filtration substrate. The modified solution includes a silane coupling agent.

### CROSS-REFERENCE TO RELATED APPLICATION

This application claims the priority benefit of Taiwan application serial no. 114118038, filed on May 14, 2025. The entirety of the above-mentioned patent application is hereby incorporated by reference herein and made a part of this specification.

### BACKGROUND

### Technical Field

The disclosure relates to a substrate and a modification method thereof, and more particularly to an air filtration substrate and a modification method thereof.

### Description of Related Art

In recent years, based on industrial development, air pollution prevention has attracted attention, and substrates for filtering air have become a major focus of industrial development, such as screens or filter meshes. In general, based on material properties, traditional screens and similar substrates for air filtration cannot effectively block suspended particulate matter in the air. Based on the above, it is an important research topic at present to develop an air filtration substrate and a modification method thereof to effectively block suspended particulate matter in the air.

### SUMMARY

The disclosure provides an air filtration substrate and a modification method thereof. An electronegativity of a surface of a substrate is modified through an electrostatic modification technology, so that the electronegativity is adjusted and the substrate naturally generates an electrostatic effect after contacting air to repel or adsorb suspended particulate matter in the air. Therefore, suspended particulate matter in the air may be effectively blocked.

A modification method of an air filtration substrate of the disclosure includes the following steps. An air filtration substrate is provided. A material of the air filtration substrate includes a first polymer or a second polymer. The first polymer is a polymer having a hydroxyl group, and the second polymer is a polymer capable of having a hydroxyl group after being coated by a resin. Thereafter, a surface of the air filtration substrate is modified with a modified solution, such that a hydroxyl group on the surface of the air filtration substrate is grafted and modified to adjust an electronegativity of the air filtration substrate. The modified solution includes a silane coupling agent.

In an embodiment of the disclosure, the resin includes an epoxy resin.

In an embodiment of the disclosure, the first polymer includes a polyamide or a polyethylene terephthalate.

In an embodiment of the disclosure, the second polymer includes a polystyrene or a polypropylene.

In an embodiment of the disclosure, a time for modifying the surface is 0.1 seconds to 24 hours.

In an embodiment of the disclosure, before the surface is modified with the modified solution, a resin coating is performed to provide the second polymer with a hydroxyl group.

In an embodiment of the disclosure, the modified solution is mixed with the resin, and when the second polymer is coated by the resin, the surface is modified at the same time.

In an embodiment of the disclosure, a mixed volume ratio of the modified solution to the resin is 1:0.01 to 1:200.

In an embodiment of the disclosure, based on a total weight of the modified solution and the resin, an added amount of the modified solution is 0.01 wt % to 50 wt %.

An air filtration substrate of the disclosure is modified through the above modification method of the air filtration substrate, and a hydroxyl group on a surface of the air filtration substrate is grafted and modified.

In an embodiment of the disclosure, the air filtration substrate includes a screen or a filter mesh.

In an embodiment of the disclosure, the filter mesh includes an air conditioner filter mesh, an automobile filter mesh, a dehumidifier filter mesh, an air purifier filter mesh, or a high-efficiency particulate air filter mesh of a clean room.

In an embodiment of the disclosure, a surface potential of the air filtration substrate is +20 V to −20 V.

Based on the above, the disclosure provides an air filtration substrate and a modification method thereof. An electronegativity of a surface of a substrate is modified through an electrostatic modification technology, such that a hydroxyl group on the surface of the air filtration substrate is grafted and modified to adjust the electronegativity, so that the substrate naturally generates an electrostatic effect after contacting air to repel or adsorb suspended particulate matter in the air. Therefore, suspended particulate matter in the air may be effectively blocked. Airborne suspended particles (such as PM2.5 and PM10) may be filtered by the electrostatic technology, and haze may be prevented from entering indoors. In addition, compared with materials such as polyvinylidene fluoride (PVDF) or polytetrafluoroethylene (PTFE), the air filtration substrate of the disclosure has the advantage of reducing cost.

### BRIEF DESCRIPTION OF THE DRAWINGS

FIGS. 1A to 1C, FIGS. 2A to 2D, and FIG. 3 are schematic diagrams of experimental results of a surface potential of an air filtration substrate of the disclosure.

### DESCRIPTION OF THE EMBODIMENTS

Hereinafter, embodiments of the disclosure will be described in detail. However, these embodiments are exemplary, and the disclosure is not limited thereto.

In this specification, a range represented by “a numerical value to another numerical value” is a summary representation to avoid listing all the numerical values within the range one by one in the specification. Therefore, the description of a specific numerical range covers any numerical value within the range and smaller numerical ranges defined by any numerical values within the range, as if the specification had specifically described the any numerical values and the smaller numerical ranges.

A modification method of an air filtration substrate of the disclosure includes the following steps. An air filtration substrate is provided. A material of the air filtration substrate includes a first polymer or a second polymer. The first polymer is a polymer having a hydroxyl group, and the second polymer is a polymer capable of having a hydroxyl group after being coated by a resin. Thereafter, a surface of the air filtration substrate is modified with a modified solution, such that a hydroxyl group on the surface of the air filtration substrate is grafted and modified to adjust an electronegativity of the air filtration substrate. The modified solution includes a silane coupling agent.

In this embodiment, for example, a silane coupling agent may be used as the modified solution. However, the disclosure is not limited thereto, and other modified solutions capable of grafting and modifying a hydroxyl group may also be selected according to actual operation requirements. That is, any modified solution having a head group that may be grafted onto a surface of a substrate to adjust a terminal R (functional group) may be applied to the disclosure. R may be any element that modifies electronegativity to make a surface carry a negative charge or a positive charge. When modified to carry a positive charge: a positive ion powder layer in contact with air may be repelled from the screen, and a negative ion powder layer may be adsorbed on the positively charged screen. When modified to carry a negative charge: a negative ion powder layer in contact with air may be repelled from the screen, and a positive ion powder layer may be adsorbed on the positively charged screen.

In this embodiment, alternative head groups may include perfluoroalkyl group (—CₙFₙ₊₁), phosphate group (—PO₃H₂), carboxyl group (—COOH), thiol group (—SH), amino group (—NH₂), sulfonic acid group (—SO₃H), boronic acid group (—B(OH)₂), isocyanate group (—N═C═O), epoxy group (—C—O—C), alkyne group (—C═C), or halogen (—Cl, —Br, —I). Based on chemical stability and wide applicability, the head groups may include siloxane group (Si—O), thiol group (—SH), phosphate group (—PO₃H₂), carboxyl group (—COOH), amino group (—NH₂), and sulfonic acid group (—SO₃H).

In this embodiment, for example, a silane coupling agent containing a perfluoroalkyl group (—CₙFₙ₊₁), a chloropropyl group (—CH₂CH₂CH₂Cl), and three methoxy groups may be used. When such a silane coupling agent is applied to a surface of the air filtration substrate, the three methoxy groups react with hydroxyl groups (—OH) on a surface of the fiber to form siloxane bonds (Si—O—Si), and the chloropropyl functional group is firmly fixed to the surface of the air filtration substrate. The negative electronegativity of the chloropropyl functional group and the particle blocking mechanism thereof are described as follows.

Surface modification and negative electronegativity enhancement: A chlorine atom (Cl) in the chloropropyl group (—CH₂CH₂CH₂Cl) has higher electronegativity and generates a distribution of negative charges. After these groups are fixed to a surface of the air filtration substrate, a local negative electronegativity is generated on the surface of the air filtration substrate. This negative electronegativity causes the fiber surface of the air filtration substrate to carry a certain static electric charge, thereby affecting an interaction between the air filtration substrate and charged particles in the air.

Electrostatic adsorption effect: The chloropropyl groups confer negative electronegativity to a surface of the air filtration substrate, allowing it to effectively adsorb suspended particles carrying positive charges in the air. For example, dust, pollen, certain pathogens, and other positively charged particulate matter may be attracted by negatively charged regions on the surface of the air filtration substrate and adhere to the fibers, thereby preventing them from passing through the air filtration substrate and entering indoors.

Electrostatic repulsion effect: Meanwhile, because a surface of the air filtration substrate carries negative electronegativity, particles also carrying negative charges may be repelled. For example, some organic pollutants, virus particles, or other negatively charged particles may be repelled due to the same negative charge on the surface of the air filtration substrate, thereby reducing the chance of these particles adhering to the surface of the air filtration substrate.

Enhanced particle blocking effect: The air filtration substrate modified with a silane coupling agent has dual electrostatic effects, as it may adsorb positively charged particles and repel negatively charged particles. This dual action may significantly improve a blocking effect of the air filtration substrate against different types of suspended particulate matter in the air, thereby enhancing a filtration performance of the air filtration substrate, especially in environments with high dust levels or serious pollution.

Chemical stability and long-term effectiveness: A stable bonding of the chloropropyl group with a surface of the fiber enables the air filtration substrate to maintain its electrostatic properties for a long time, and still continuously exert an effect of blocking suspended particulate matter even under outdoor conditions or frequent washing. This chemical stability ensures a long-term effectiveness of the surface treatment of the air filtration substrate and reduces the need for repeated treatments.

Such a silane coupling agent, by introducing chloropropyl functional groups, increases negative electronegativity of a surface of fibers of the air filtration substrate. This negatively charged surface may adsorb positively charged particles and repel negatively charged particles, forming a dual electrostatic filtration effect. As a result, the air filtration substrate treated with such a silane coupling agent may not only effectively block various types of airborne suspended particles, but also maintain long-term filtration performance.

For example, a silane coupling agent containing one aminopropyl group (—CH₂CH₂CH₂NH₂) and three ethoxy groups (—OCH₂CH₃) may be used. When applied for surface modification of fibers of the air filtration substrate, the ethoxy groups in the silane coupling agent react with hydroxyl groups (—OH) on surfaces of fibers of the air filtration substrate to form stable siloxane bonds (Si—O—Si). This process fixes amino functional groups of the aminopropyl group to surfaces of fibers of the air filtration substrate. The positive electronegativity of such a silane coupling agent and the particle blocking mechanism are described as follows.

Positive electronegativity of amino functional group: In an aqueous or slightly acidic environment, the amino functional groups (—NH₂) on the silane coupling agent are easily protonated into ammonium groups (—NH₃⁺) carrying positive charges. This positive electronegativity causes surfaces of fibers of the air filtration substrate to carry local positive charges. After the air filtration substrate is modified with such a silane coupling agent, the surface has positive electronegativity, thereby affecting its interaction with airborne particles.

Electrostatic adsorption effect: Due to the positive charges of the amino functional groups, a surface of the air filtration substrate modified with such a silane coupling agent may effectively adsorb suspended particles carrying negative charges. Most pollutants in the air (such as certain components in PM2.5, virus particles, bacteria, dust, and organic pollutants) usually carry negative charges. These negatively charged particles are attracted by the positive charges on the air filtration substrate when approaching the surface of the air filtration substrate, thereby being adsorbed onto the fiber surface. This adsorption effect may significantly reduce the possibility of these particles entering indoors.

Electrostatic repulsion effect: Conversely, because the surface of the air filtration substrate carries positive electronegativity, it repels particles also carrying positive charges. For example, some cationic pollutants or particles in the air may be repelled by the positively charged surface of the air filtration substrate. This electrostatic repulsion effect further reduces the chance of these particles adhering to the air filtration substrate.

Enhanced particle filtration performance: The air filtration substrate modified with such a silane coupling agent has dual functions of electrostatic adsorption and repulsion. It may effectively adsorb suspended particles carrying negative charges and simultaneously repel particles carrying positive charges. This electrostatic effect significantly improves a filtration performance of the air filtration substrate against various types of suspended particulate matter in the air. Since most suspended pollutants in the environment carry negative charges, the positively charged surface of such a silane coupling agent may specifically enhance the capture ability for these particles.

Enhanced material stability: The stable chemical bonding (Si—O—Si) of such a silane coupling agent on the surface enables amino functional groups to be fixed on surfaces of fibers of the air filtration substrate for a long time and not easily fall off. This chemical stability ensures that the positive electronegativity of the air filtration substrate remains effective for a long time, maintaining its electrostatic blocking performance against suspended particulate matter, and the effect remains durable even under conditions of outdoor use or washing.

Such a silane coupling agent, by introducing amino functional groups onto surfaces of fibers, makes a surface of the air filtration substrate carry positive electronegativity, and may effectively adsorb suspended particles carrying negative charges (such as dust, bacteria, and virus particles) and repel particles carrying positive charges. This dual electrostatic filtration effect significantly enhances a filtration performance of the air filtration substrate and is applicable to various environments requiring high-efficiency filtration. The air filtration substrate treated with such a silane coupling agent may effectively improve a blocking ability against various types of air pollutants without affecting ventilation.

In this embodiment, the first polymer is a polymer having a hydroxyl group and may include a polyamide (PA) or a polyethylene terephthalate (PET). However, the disclosure is not limited thereto, and other polymers having a hydroxyl group may also be selected according to actual operation requirements. The second polymer is a polymer capable of having a hydroxyl group after being coated by a resin and may include a polystyrene (PS) or a polypropylene (PP). However, the disclosure is not limited thereto, and other polymers capable of having a hydroxyl group after being coated by a resin may also be selected according to actual operation requirements. The resin may include an epoxy resin. However, the disclosure is not limited thereto, and other resins capable of providing a polymer with a hydroxyl group after coating may also be selected according to actual operation requirements.

In this embodiment, a time for performing surface modification is, for example, 0.1 seconds to 24 hours. When a material of the air filtration substrate is the second polymer, a resin coating may be performed first to provide the second polymer with a hydroxyl group before a surface is modified with the modified solution. Alternatively, the modified solution may be mixed with the resin, and when the resin coating is performed on the second polymer, the surface modification is simultaneously performed, wherein a mixed volume ratio of the modified solution to the resin is, for example, 1:0.01 to 1:200. Alternatively, based on a total weight of the modified solution and the resin, an added amount of the modified solution is, for example, 0.01 wt % to 50 wt %.

The disclosure also provides an air filtration substrate modified through the above modification method of the air filtration substrate. A hydroxyl group on a surface of the air filtration substrate is grafted and modified. Therefore, an electronegativity is adjusted, and an electrostatic effect may be generated to repel or adsorb suspended particulate matter in the air, so that suspended particulate matter in the air may be effectively blocked. In this embodiment, the air filtration substrate may include a screen or a filter mesh. The filter mesh may include an air conditioner filter mesh, an automobile filter mesh, a dehumidifier filter mesh, or an air purifier filter mesh. However, the disclosure is not limited thereto. That is, the air filtration substrate of the disclosure may also include any other substrate having air filtration effect and function. A surface potential of the air filtration substrate is, for example, +20 V to −20 V.

The air filtration substrate of the disclosure is electrostatically treated and may adsorb and filter suspended particulate matter in the air (such as PM2.5, PM10, etc.). A working principle thereof is mainly based on electrostatic adsorption. When air flows through the air filtration substrate, the air filtration substrate carrying static electricity may adsorb suspended particles, thereby blocking outdoor pollutants from entering indoors.

The following is a more detailed introduction to technical features of the air filtration substrate of the disclosure:

Electrostatic mesh layer: The air filtration substrate contains multiple layers of special mesh layers carrying static electricity. These mesh layers are usually made of polyester fibers or other materials having electrostatic adsorption properties, and these materials may be processed by special treatments (such as corona discharge or other electrostatic treatments) to carry static charges.

Electrostatic adsorption: When air flows through the air filtration substrate, fine particles in the air (such as dust, pollen, bacteria, etc.) are attracted by the electrostatic mesh layers and captured on surfaces of the mesh layers. Since these particles usually carry different charges, they are easily adsorbed by electrostatic fields in the mesh layers.

Multilayer filtration: The air filtration substrate is usually designed as a multilayer structure to improve a filtration effect thereof. Each mesh layer has different mesh sizes and static charges, and may effectively capture particles of different sizes, thereby achieving higher filtration efficiency.

Air permeability: Although the air filtration substrate has a filtration function, a design thereof maintains a certain air permeability, allowing fresh air to flow indoors while blocking pollutants from entering. This design balances a haze-proof effect and a natural ventilation demand.

Cleaning and maintenance: The air filtration substrate will accumulate particles over time, so regular cleaning and maintenance are required to maintain a filtration effect thereof. In general, a vacuum cleaner may be used to gently vacuum, or clean water may be used to rinse to remove accumulated particles.

In general, a principle of the air filtration substrate of the disclosure lies in utilizing electrostatic force to adsorb fine particles in the air, thereby achieving an anti-haze effect while allowing fresh air to flow.

The following are advantages of the air filtration substrate of the disclosure:
(1) Blocking external pollution sources: Effectively preventing outdoor PM2.5, dust, pollen, and other pollutants from entering indoors, and particularly effective in combating atmospheric pollution.
(2) Energy saving: No need for electric power drive, and functioning by relying on natural ventilation.
(3) Good air permeability: Compared with completely closed windows, the air filtration substrate may maintain good ventilation effects and reduce problems of humidity and odor in indoor air.
(4) Easy installation: The air filtration substrate may be directly installed on existing windows, and installation and replacement are relatively simple with lower costs.

Hereinafter, experimental examples are used to describe in detail the above air filtration substrate and the modification method thereof of the disclosure. However, the following experimental examples are not intended to limit the disclosure.

### EXPERIMENTAL EXAMPLE

In order to prove that the electronegativity of the air filtration substrate could be adjusted by the modification method of the disclosure to generate an electrostatic effect and repel or adsorb suspended particulate matter in the air, the following experimental example was specially conducted.

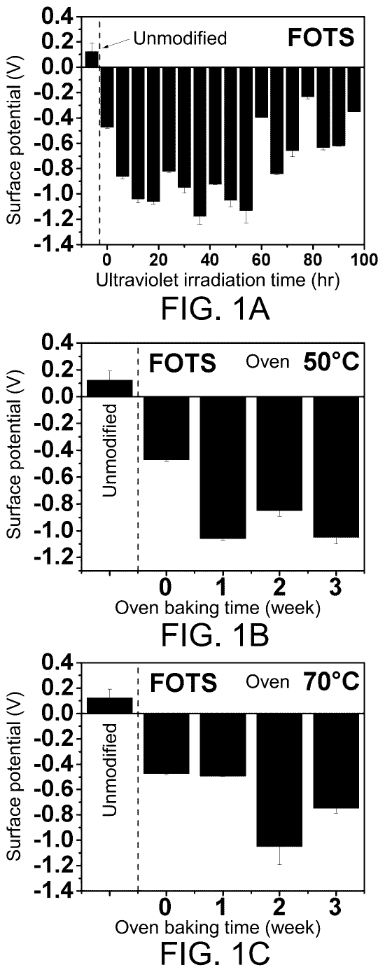

FIGS. 1A to 1C, FIGS. 2A to 2D, and FIG. 3 are schematic diagrams of experimental results of a surface potential of an air filtration substrate of the disclosure.

### Modification Method of Filtration Substrate

In the experimental example, the modification method using FOTS of Example 1, the modification method using CPTMS of Example 2, and the modification method using APTES and TMSI of Example 3 are detailed as follows:

In a glass beaker with a volume of 500 milliliters, anhydrous alcohol (original volume concentration >99.5%) and a modification solution (original volume concentration >99%) were sequentially added. Based on a total weight of the modified solution and the resin, an added amount of the modified solution was 5 wt % to 30 wt %. A magnetic stir bar was used to stir the solution on a stirrer at a speed of 300 rpm at room temperature and atmospheric pressure for 10 minutes to uniformly mix the solution. Next, a filtration substrate to be modified was placed into the solution. The size of the substrate was 5 centimeters in length and 5 centimeters in width. The substrate was completely immersed in the solution and stirring was continued. After being modified for 5 minutes, the modified filtration substrate was taken out using stainless steel tweezers. The surface of the substrate was then washed with deionized water and alcohol (volume concentration 95%) and subsequently placed into an oven at 50 °C for 2 hours to dry the liquid on the surface of the substrate.

### Example 1

Referring to FIGS. 1A to 1C, the surface of a PET screen was modified with a FOTS silane coupling agent for 5 minutes. A surface potential was measured by a Kelvin probe force microscope and was reduced to between +20 V and −20 V. After ultraviolet irradiation for 100 hours (FIG. 1A) and oven baking for 3 weeks, the surface potential was still maintained at about −0.8 V (FIGS. 1B to 1C).

### Example 2

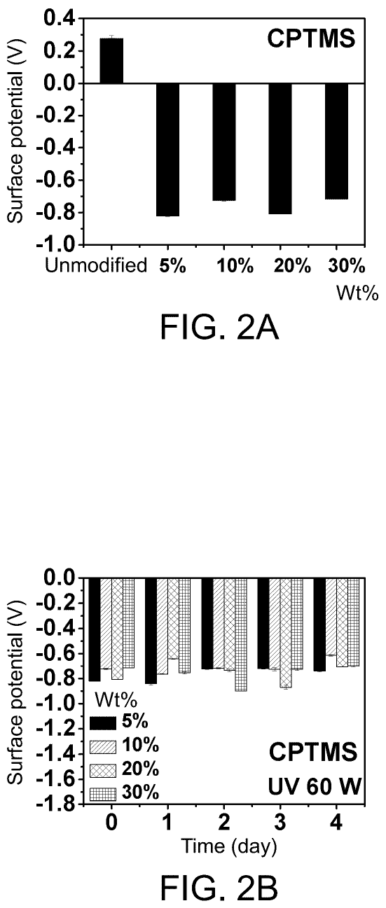

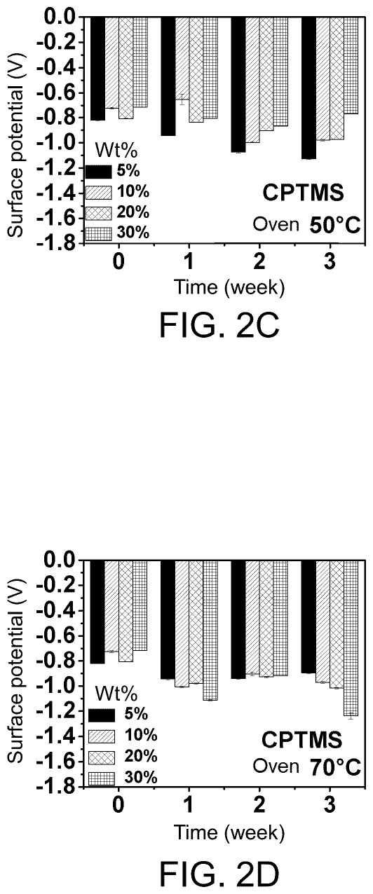

Referring to FIGS. 2A to 2D, the surface of a PET screen was modified with a CPTMS silane coupling agent for 5 minutes. A surface potential was reduced to between −0.8 V and −0.6 V (FIG. 2A). After continuous ultraviolet irradiation for 4 days (FIG. 2B), oven baking for 3 weeks at 50 °C. (FIG. 2C), and oven baking at 70 °C. (FIG. 2D), the surface potential was still maintained between −0.7 V and −1.1 V.

### Example 3

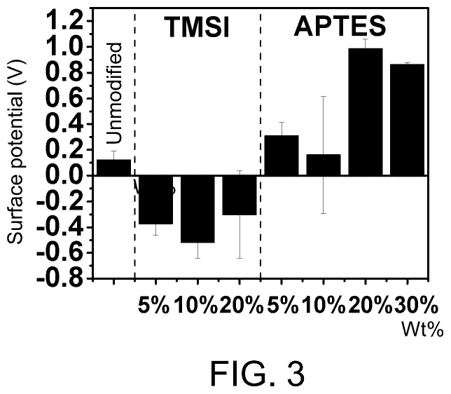

Referring to FIG. 3, the surface of a PET screen was modified with a silane coupling agent TMSI and APTES for 5 minutes. After TMSI modification, a surface potential was reduced to between −0.6 V and −0.4 V. After APTES modification, a surface potential was increased to between 0.2 V and −1.0 V.

### Bond Energy Comparison

### Analytical Test Methods

1. By mass spectrometry (MS) operating principle:

Molecules were fragmented through high-energy electrons or lasers, and an energy at the time of bond breaking was measured to estimate bond energy.
2. By Fourier transform infrared spectroscopy (FTIR), characteristic absorption peaks of molecular functional groups were analyzed to determine a strength and change of bonds such as C—O and C—O. It was used to monitor changes of bonds under different conditions and infer bond energy.
3. By Raman spectroscopy

Operating principle:

Bond vibration frequencies of molecules were measured to infer bond strength.

It was particularly sensitive to double bonds such as C═O (ester group).

### Bond Energy in PET (Window Material) Chains

PET was composed of alternating terephthalate and ethylene glycol units, connected by ester bonds (C═O) and C—O bonds, with some single C—C bonds in a polymer main chain.

| Bond Type | Bond Energy (kcal/mol) | | Comment |
|---|---|---|---|
| C—C (in polymer | 83-85 | kcal/mol | Relatively stable due to the |
| main chain) | | | saturated nature of C—C |
| | | | bonds. |
| C—O (single | 78-85 | kcal/mol | Common in ether or ester |
| bond) | | | bonds. |
| C═O (in ester | 170-190 | kcal/mol | One of the strongest bonds |

| | |
|---|---|
| group) | in PET, contributing to |
| | thermal stability and |
| | mechanical stability. |

Comparison: Bonding of Si—O—Si in Modified Solution with PET

| Bond Type | Bond Energy (kcal/mol) | | Comment |
|---|---|---|---|
| Si—O—Si | 200-150 | kcal/mol | Stronger than C—C and |
| (in modified | | | C—O bonds in PET, |
| solution) | | | but weaker than C═O |
| | | | bonds in PET. |
| C—C (in polymer | 83-85 | kcal/mol | Si—O—Si bond is |
| main chain) | | | significantly stronger. |
| C—O (single | 78-85 | kcal/mol | Si—O—Si bond |
| bond) | | | is stronger. |
| C═O (in ester | 170-190 | kcal/mol | Si—O—Si bond is |

| | |
|---|---|
| group) | weaker than the carbonyl |
| | bond of ester group. |

Based on the above comparison, it may be known that the Si—O—Si bond in the modified solution is stronger than the C—C and C—O bonds in PET by about 20-65 kcal/mol. The C═O bond in PET is stronger than the Si—O—Si bond in the modified solution by about 20-90 kcal/mol. The Si—O—Si bond in the modified solution is generally stronger than the polymer main chain bonds of PET (C—C and C—O bonds), but weaker than the strongest bond in PET, which is the ester carbonyl bond (C═O). This comparison highlights the relative stability of the Si—O—Si bond in the modified solution, making it more robust than the inert PET structure but more reactive.

In summary, the disclosure provides an air filtration substrate and a modification method thereof. An electronegativity of a surface of a substrate is modified through an electrostatic modification technology, so that a hydroxyl group on the surface of the air filtration substrate is grafted and modified to adjust the electronegativity. Thereby, the substrate naturally generates an electrostatic effect after contacting air to repel or adsorb suspended particulate matter in the air, and thus may effectively block suspended particulate matter in the air. In addition, compared with materials such as polyvinylidene fluoride (PVDF) or polytetrafluoroethylene (PTFE), the air filtration substrate of the disclosure has the advantage of reducing costs. Moreover, experimental results proved that even after high-temperature baking or long-term ultraviolet irradiation, a surface potential of the air filtration substrate of the disclosure may still be maintained at a certain level. Therefore, it may be known that the air filtration substrate of the disclosure may also maintain a certain level of performance under practical application environments and may effectively block suspended particulate matter in the air.

What is claimed is:

1. A modification method of an air filtration substrate, comprising:
providing an air filtration substrate, wherein a material of the air filtration substrate comprises a first polymer or a second polymer, the first polymer is a polymer having a hydroxyl group, and the second+polymer is a polymer capable of having a hydroxyl group after being coated by a resin; and
modifying a surface of the air filtration substrate with a modified solution, such that a hydroxyl group on the surface of the air filtration substrate is grafted and modified to adjust an electronegativity of the air filtration substrate, wherein the modified solution comprises a silane coupling agent.

2. The modification method of the air filtration substrate according to claim 1, wherein the resin comprises an epoxy resin.

3. The modification method of the air filtration substrate according to claim 1, wherein the first polymer comprises a polyamide or a polyethylene terephthalate.

4. The modification method of the air filtration substrate according to claim 1, wherein the second polymer comprises a polystyrene or a polypropylene.

5. The modification method of the air filtration substrate according to claim 1, wherein a time for modifying the surface is 0.1 seconds to 24 hours.

6. The modification method of the air filtration substrate according to claim 1, wherein before the surface is modified with the modified solution, a resin coating is performed to provide the second polymer with a hydroxyl group.

7. The modification method of the air filtration substrate according to claim 1, wherein the modified solution is mixed with the resin, and when the second polymer is coated by the resin, the surface is modified at the same time.

8. The modification method of the air filtration substrate according to claim 7, wherein a mixed volume ratio of the modified solution to the resin is 1:0.01 to 1:200.

9. The modification method of the air filtration substrate according to claim 7, wherein based on a total weight of the modified solution and the resin, an added amount of the modified solution is 0.01 wt % to 50 wt %.

10. An air filtration substrate, modified through the modification method of the air filtration substrate according to claim 1.

11. The air filtration substrate according to claim 10, wherein the air filtration substrate comprises a screen or a filter mesh.

12. The air filtration substrate according to claim 11, wherein the filter mesh comprises an air conditioner filter mesh, an automobile filter mesh, a dehumidifier filter mesh, or an air purifier filter mesh.

13. The air filtration substrate according to claim 10, wherein a surface potential of the air filtration substrate is +20 V to −20 V.
